(19) United States
(12) Patent Application Publication
(10) Pub. No.: US 2014/0237164 A1
(43) Pub. Date: Aug. 21, 2014

(54) HYBRID DRIVE THAT IMPLEMENTS A DEFERRED TRIM LIST

(71) Applicant: KABUSHIKI KAISHA TOSHIBA, Tokyo (JP)

(72) Inventors: Annie Mylang LE, San Jose, CA (US); Fernando Anibal ZAYAS, Rangiora (NZ)

(73) Assignee: KABUSHIKI KAISHA TOSHIBA, Tokyo (JP)

(21) Appl. No.: 13/770,804

(22) Filed: Feb. 19, 2013

(51) Int. Cl. G06F 12/02

(52) U.S. Cl. CPC G06F 12/0246
USPC 711/103

(57) ABSTRACT

A hybrid drive controller maintains a deferred trim list that holds a subset of logical addresses of writes performed on magnetic disks. For example, if a write command is issued to an LBA space that overlaps a portion stored in flash memory and the write is to be performed on the magnetic disks, the trimming of the overlapping portion in the flash memory will be deferred. Instead of trimming, the logical addresses associated with the overlapping portion will be added to the deferred trim list and trimming of the logical addresses in the deferred trim list will be carried out at a later time, asynchronous to the write that caused them to be added to the list.

### FIELD

Embodiments described herein relate generally to data storage units, systems and methods for storing data in a hybrid disk drive.

### DESCRIPTION OF THE RELATED ART

Hybrid hard disk drives (HDDs) include one or more rotating magnetic disks combined with non-volatile solid-state (e.g., flash) memory. Generally, a hybrid HDD has both the capacity of a conventional HDD and the ability to access data as quickly as a solid-state drive, and for this reason hybrid drives are expected to be commonly used in laptop computers.

During use, write commands are issued to the hybrid HDDs by a connected host. In response, the data to be written may be stored in the magnetic disks or in the flash memory. At various times, a write command will be issued to an LBA space that overlaps a portion stored in the flash memory. When the flash memory does not have sufficient capacity to satisfy this write, the write will be performed on the magnetic disks and the overlapping portion in the flash memory will be trimmed (i.e., marked as being unavailable). Based on the way conventional trimming techniques are carried out, if the write to the magnetic disks is aborted before it completes and a subsequent read to the same LBA space is issued, the locations in the flash memory corresponding to this LBA space will have been trimmed and so the read will return data from the locations in the magnetic disks corresponding to this LBA space. The returned data can be old and can leak information from a previous use of the locations.

### SUMMARY

One or more embodiments provide a deferring trim technique that protects against data leaks noted above. According to this technique, a hybrid drive controller maintains a deferred trim list that holds a subset of logical addresses of writes performed on magnetic disks. For example, if a write command is issued to an LBA space that overlaps a portion stored in the flash memory and the write is to be performed on the magnetic disks, the trimming of the overlapping portion in the flash memory will be deferred. Instead of trimming, the logical addresses associated with the overlapping portion will be added to the deferred trim list and trimming of the logical addresses in the deferred trim list will be carried out at a later time, asynchronous to the write that caused them to be added to the list.

A method of writing data in a hybrid drive, according to an embodiment, includes receiving a command to write data, determining that a non-volatile solid-state device has a valid block with a logical address referenced by the command, writing the data to one or more blocks of a magnetic storage medium, one of which has the same logical address as the valid block, and invalidating the valid block of the non-volatile solid-state device after some time after the data writing has elapsed.

A method of reading data from a hybrid drive, according an embodiment, includes receiving a command to read data from a block associated with a logical address, determining whether or not the logical address is included in a list of logical addresses of blocks one of the non-volatile solid-state device to be invalidated, and reading the data from either a block of the magnetic storage medium or a block of the non-volatile solid-state device.

A hybrid drive according to an embodiment includes a controller configured to control writing of data to blocks of a magnetic storage medium and to blocks of a non-volatile solid-state device in response to a command to write data to a block associated with a logical address and to invalidate a block of the non-volatile solid-state device associated with the logical address after writing the data in a block of the magnetic storage medium associated with the logical address if the non-volatile solid-state device has a valid block associated with the logical address of the command.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a schematic view of a hybrid drive according to an embodiment.

FIG. 2 is a block diagram of the hybrid drive of FIG. 1 with electronic circuit elements configured according to an embodiment.

FIG. 3A illustrates a mapping table maintained for a non-volatile solid-state device that is configured in the hybrid drive of FIG. 1.

FIG. 3B illustrates a mapping table maintained for a magnetic storage medium that is configured in the hybrid drive of FIG. 1.

FIG. 3C illustrates a deferred trim list that is used in the embodiments.

FIG. 4 is a flowchart of method steps that are carried out during execution of a write request according to the embodiment.

FIG. 5 is a flowchart of method steps that are carried out during processing of a deferred trim list according to the embodiment.

FIG. 6 is a flowchart of method steps that are carried out during execution of a read request according to the embodiment.

### DETAILED DESCRIPTION

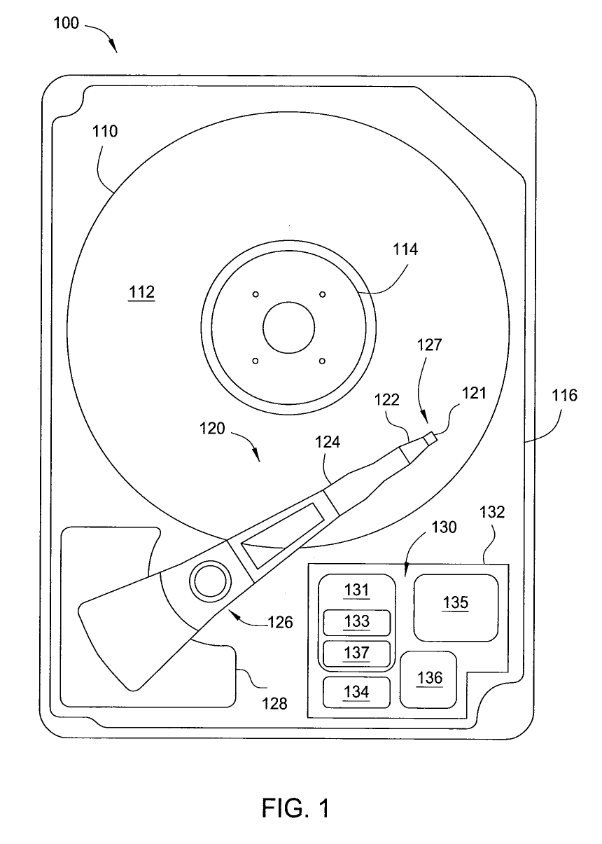

FIG. 1 is a schematic view of an exemplary disk drive according to an embodiment. For clarity, hybrid drive 100 is illustrated without a top cover. Hybrid drive 100 includes at least one storage disk 110 that is rotated by a spindle motor 114 and includes a plurality of concentric data storage tracks. Spindle motor 114 is mounted on a base plate 116. An actuator arm assembly 120 is also mounted on base plate 116, and has a slider 121 mounted on a flexure arm 122 with a read/write head 127 that reads data from and writes data to the data storage tracks. Flexure arm 122 is attached to an actuator arm 124 that rotates about a bearing assembly 126. Voice coil motor 128 moves slider 121 relative to storage disk 110, thereby positioning read/write head 127 over the desired concentric data storage track disposed on the surface 112 of storage disk 110. Spindle motor 114, read/write head 127, and voice coil motor 128 are coupled to electronic circuits 130, which are mounted on a printed circuit board 132. Electronic circuits 130 include a read channel 137, a microprocessor-based controller 133, random-access memory (RAM) 134 (which may be a dynamic RAM and is used as a data buffer), and/or a flash memory device 135 and flash manager device 136. In some embodiments, read channel 137 and microprocessor-based controller 133 are included in a single chip, such as a system-on-chip 131. In some embodiments, hybrid drive 100 may further include a motor-driver chip for driving spindle motor 114 and voice coil motor 128. In addition, other non-volatile solid state memory may be used in place of flash memory device 135.

For clarity, hybrid drive 100 is illustrated with a single storage disk 110 and a single actuator arm assembly 120. Hybrid drive 100 may also include multiple storage disks and multiple actuator arm assemblies. In addition, each side of storage disk 110 may have an associated read/write head coupled to a flexure arm.

When data are transferred to or from storage disk 110, actuator arm assembly 120 sweeps an arc between an inner diameter (ID) and an outer diameter (OD) of storage disk 110. Actuator arm assembly 120 accelerates in one angular direction when current is passed in one direction through the voice coil of voice coil motor 128 and accelerates in an opposite direction when the current is reversed, thereby allowing control of the position of actuator arm assembly 120 and attached read/write head 127 with respect to storage disk 110. Voice coil motor 128 is coupled with a servo system known in the art that uses the positioning data read from servo wedges by read/write head 127 to determine the position of read/write head 127 over a specific data storage track. The servo system determines an appropriate current to drive through the voice coil of voice coil motor 128, and drives said current using a current driver and associated circuitry.

Hybrid drive 100 is configured as a hybrid drive, and in normal operation data can be stored to and retrieved from storage disk 110 and/or flash memory device 135. In a hybrid drive, non-volatile memory, such as flash memory device 135, supplements the spinning storage disk 110 to provide faster boot, hibernate, resume and other data read-write operations, as well as lower power consumption. Such a hybrid drive configuration is particularly advantageous for battery operated computer systems, such as mobile computers or other mobile computing devices. In a preferred embodiment, flash memory device is a non-volatile solid state storage medium, such as a NAND flash chip that can be electrically erased and reprogrammed, and is sized to supplement storage disk 110 in hybrid drive 100 as a non-volatile storage medium. For example, in some embodiments, flash memory device 135 has data storage capacity that is orders of magnitude larger than RAM 134, e.g., gigabytes (GB) vs. megabytes (MB).

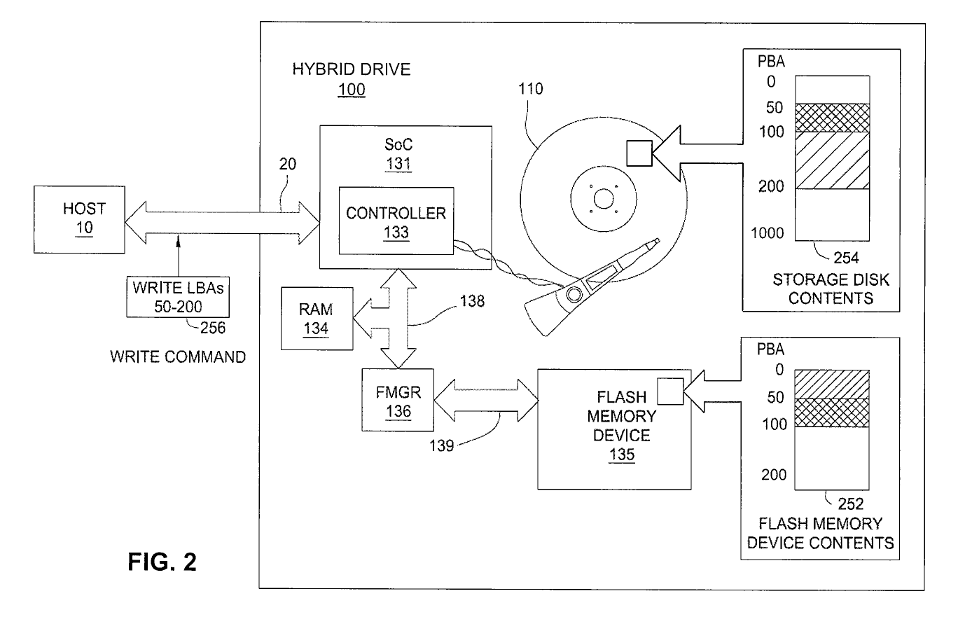

FIG. 2 is a block diagram of hybrid drive 100 with elements of electronic circuits 130 configured according to an embodiment. As shown, hybrid drive 100 includes RAM 134, flash memory device 135, a flash manager device 136, system-on-chip 131, and a high-speed data path 138. Hybrid drive 100 is connected to a host 10, such as a host computer, via a host interface 20, such as a serial advanced technology attachment (SATA) bus.

In the embodiment illustrated in FIG. 2, flash manager device 136 controls interfacing of flash memory device 135 with high-speed data path 138 and is connected to flash memory device 135 via a NAND interface bus 139. System-on-chip 131 includes microprocessor-based controller 133 and other hardware (including a read channel) for controlling operation of hybrid drive 100, and is connected to RAM 134 and flash manager device 136 via high-speed data path 138. Microprocessor-based controller 133 is a control unit that may include a microcontroller such as an ARM microprocessor, a hybrid drive controller, and any control circuitry within hybrid drive 100. High-speed data path 138 is a high-speed bus known in the art, such as a double data rate (DDR) bus, a DDR2 bus, a DDR3 bus, or the like.

Data transferred to flash memory device 135 may be write data accepted directly from host 10 as part of a write request or as data read from storage disk 110 as part of a read request. When data are transferred to NAND-type flash memory device 135, the data are written to blocks of NAND memory that have been erased previously; if insufficient erased blocks are present in flash memory device 135, additional memory blocks should first be erased before the desired data are transferred to flash memory device 135.

Hybrid drive 100 stores data in physical blocks of storage disk 110 and flash memory device 135. The physical blocks each have a physical block address (PBA) and they are shown in the schematic illustrations of flash memory device contents 252 and storage disk contents 254. In this example, after receiving a write command 256 from host 10, hybrid drive 100 determines whether flash memory device 135 contains sufficient space to store the write data in flash memory device 135. If flash memory device 135 does not contain sufficient space, hybrid drive 100 stores the write data in storage disk 110. If write data stored in storage disk 110 is associated with LBAs that are currently mapped to physical blocks of flash memory device 135, such physical blocks need to be marked as invalid so that a subsequent read to the LBAs will not return the stale contents of such physical blocks of flash memory device 135. According to embodiments disclosed herein, such physical blocks are not immediately marked invalid. Instead, the LBAs that are mapped to such physical blocks are added to a deferred trim list and, when the deferred trim list is processed, these physical blocks are marked as invalid. The processing of the deferred trim list may occur at any time after the writes (i.e., asynchronous with respect to such writes) to the LBAs that caused the LBAs to be added to the deferred trim list, have been deemed to be successful.

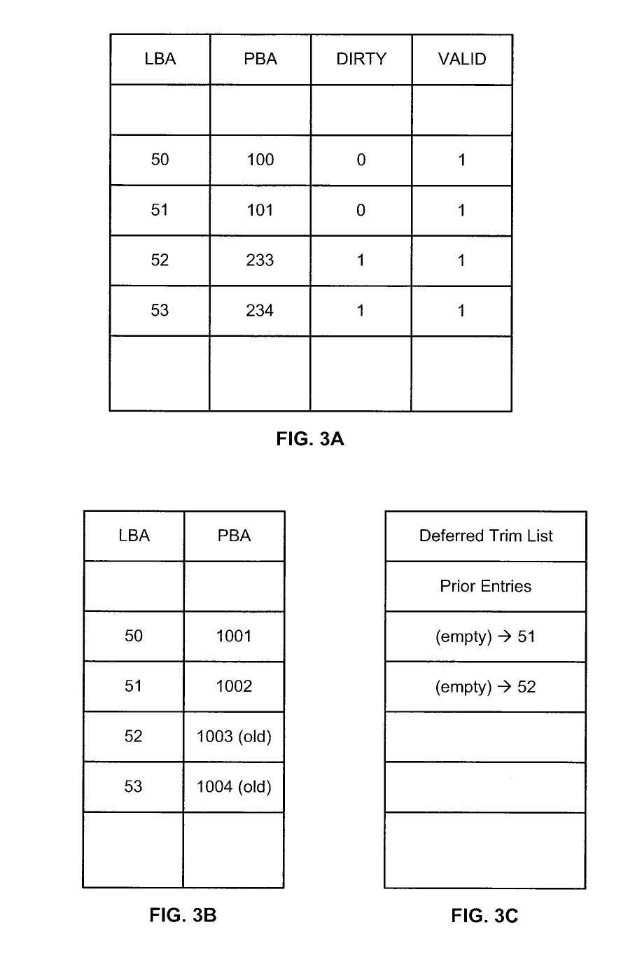

The mapping table illustrated in FIG. 3A (hereinafter referred to as flash memory mapping table) provides a mapping of the LBAs to PBAs of flash memory device 135 and for each LBA entry indicates whether the contents stored in corresponding physical block of flash memory device 135 is dirty (i.e., updated only in flash memory device 135 such that contents of the LBA of flash memory device 135 and the same LBA of storage disk 110 may be different) and/or valid. The contents stored in a particular LBA of flash memory device 135 may be invalid because the corresponding LBA of storage disk 110 has been updated with new data.

The mapping table illustrated in FIG. 3B (hereinafter referred to as storage disk mapping table) provides a mapping of the LBAs to PBAs of storage disk 110. In the example shown, the physical block 1002 (corresponding to LBA 51) has the same contents as the physical block 101 of flash memory device 135 (also corresponding to LBA 51). On the other hand, the physical block 1003 (corresponding to LBA 52) does not have the same contents as the physical block 233 of flash memory device 135 (also corresponding to LBA 52) because the contents of the physical block 233 of flash memory device 135 is marked as dirty. In some embodiments, in place of the mapping table of FIG. 3B, a mapping function may be used.

FIG. 3C illustrates a deferred trim list that is used in the embodiments. The deferred trim list includes a list of LBAs that are to be trimmed. As described above, when the deferred trim list is processed, the physical blocks associated with the LBAs in the deferred trim list are marked as invalid. In the example shown, it is assumed that writes to LBA 51 and LBA 52 of storage disk 110 are being processed. LBA 51 and LBA 52 both have valid physical blocks in flash memory device 135 and therefore they are added to the deferred trim list. It should be understood that, if only LBA 51 has a valid physical block in flash memory device 135, only LBA 51 would have been added to the deferred trim list, and if only LBA 52 has a valid physical block in flash memory device 135, only LBA 52 would have been added to the deferred trim list.

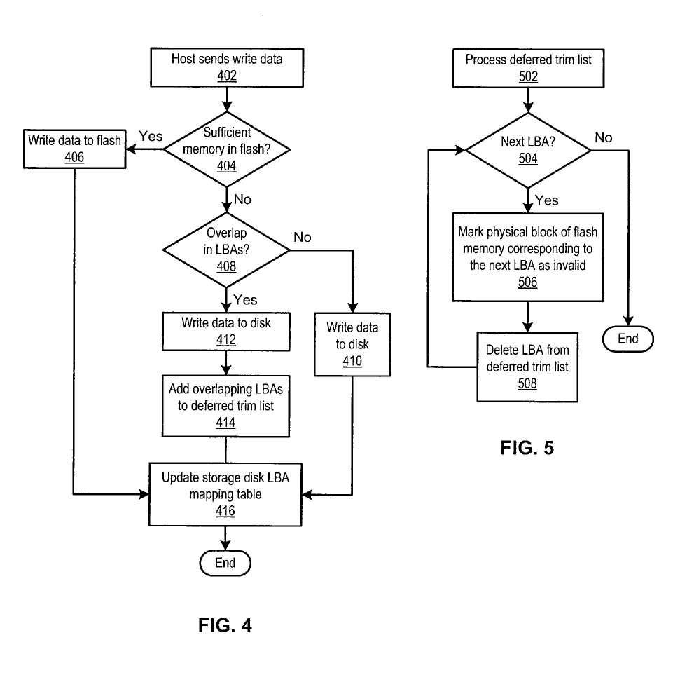

FIG. 4 is a flowchart of method steps that are carried out during execution of a write request according to an embodiment. In the embodiment described here, controller 133 is performing these steps and accessing the flash memory mapping table, the storage disk mapping table, and the deferred trim list during this method.

This method begins at step 402, during which host 10 sends a write command to hybrid drive 100, the write command including the write data and LBAs in which to store the write data. At step 404, controller 133 determines whether flash memory device 135 has sufficient space to accept the write data. At step 406, if flash memory device 135 has sufficient space, controller 133 writes the data into flash memory device 135 and proceeds to step 416 where it updates the flash memory mapping table.

If controller 133 determines at step 404 that flash memory device 135 has insufficient space to store the write data, controller 133 at step 408 determines whether the LBAs associated with the write data overlap valid blocks in flash memory device 135. Controller 133 may base this determination on the flash memory mapping table. At step 410, if no such overlap exists, controller 133 writes the data into the physical blocks of storage disk 110 corresponding to the LBAs and proceeds to step 416, where it updates the storage disk mapping table.

If controller 133 at step 408 determines that the LBAs associated with the write data overlap valid blocks in flash memory device 135, steps 412 and 414 are carried out. At step 412, controller 133 writes the data into the physical blocks of storage disk 110 corresponding to the LBAs. At step 414, the LBAs of overlapping blocks are added to the deferred trim list. After step 414, step 416 is carried out where controller 133 updates the storage disk mapping table. It should be noted that the flash memory mapping table is not updated at step 416 to indicate the overlapping blocks as being invalid. Such updates are performed at a later time according to the method shown in FIG. 5.

FIG. 5 is a flowchart of method steps that are carried out to trim physical blocks of flash memory device 135 that are associated with LBAs that were added to the deferred trim list. In the embodiment described here, controller 133 is performing these steps and accessing the flash memory mapping table and the deferred trim list during this method. This method may be carried out as a background process and may be executed periodically or during times when controller 133 is idle or less busy periods of controller 133. This method may also be carried out at the completion of each or a group of write commands.

The triggering of this method is shown by step 502. Upon this triggering, the method consumes the next LBA in the deferred trim list. If there are no more LBAs in the deferred trim list as determined at step 504, the method terminates. However, if there are more LBAs in the deferred trim list as determined at step 504, the next LBA in the list is retrieved and the physical block of flash memory device 135 corresponding to this next LBA is marked as being invalid at step 506. For example, referring back to FIGS. 3A and 3C, when LBA 51 is consumed from the deferred trim list, the entry in the flash memory mapping table corresponding to LBA 51 and physical block 101 will be indicated as being invalid (e.g., valid bit is changed from 1 to 0 or the entry removed from the table). Also, when LBA 52 is consumed from the deferred trim list, the entry in the flash memory mapping table corresponding to LBA 52 and physical block 233 will be indicated as being invalid (e.g., valid bit is changed from 1 to 0 or the entry removed from the table). At step 508, the LBA that has been consumed is deleted from the deferred trim list. After step 508, the flow of the method returns to step 504.

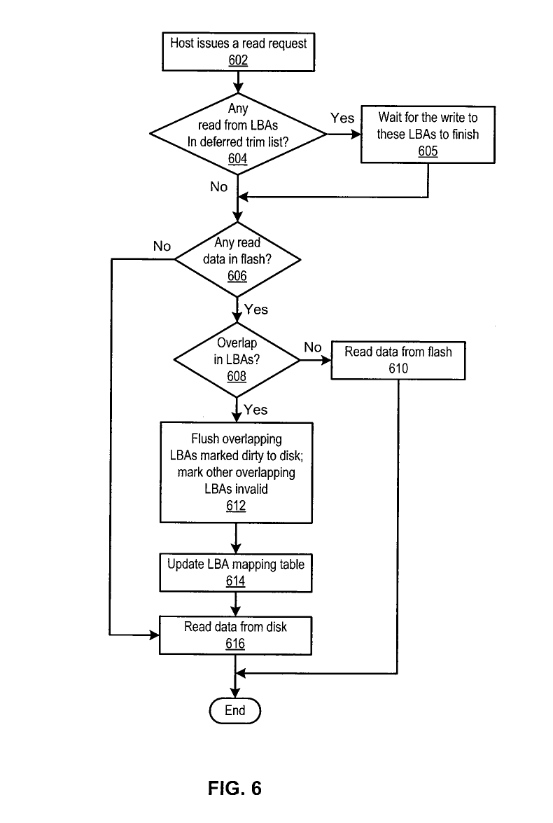

FIG. 6 is a flowchart of method steps that are carried out during execution of a read request according to an embodiment. In the embodiment described here, controller 133 is performing these steps and accessing the flash memory mapping table, the storage disk mapping table, and the deferred trim list during this method.

This method begins at step 602, during which host 10 sends a read command to hybrid drive 100, the read command including the LBAs from which to obtain the read data. At step 604, controller 133 accesses the deferred trim list and determines whether any of the LBAs is included in the deferred trim list. If one or more LBAs are included in the deferred trim list, controller 133 at step 605 waits for the write to the storage disk of these overlapped LBAs to finish in order for the trimming of the flash memory to proceed. After the trim, the flash memory mapping table and the entries in the flash memory mapping table corresponding to these LBAs will be indicated as being invalid (e.g., valid bit is changed from 1 to 0 or the entry removed from the table). At step 606, controller 133 examines the flash memory mapping table to determine whether there are any valid blocks associated with the LBAs of the read command. If there are none, step 616 is carried out and the read data is retrieved from storage disk 110 using the storage disk mapping table.

On the other hand, if there are valid blocks associated with LBAs of the read command not in the flash memory mapping table, step 608 is carried out. At step 608, controller 133 determines if there is an overlap in the LBAs of the read command so that they map to both blocks of flash memory device 135 and blocks of storage disk 110. If there is no overlap, the read data is retrieved from flash memory device 135 at step 610 using the flash memory mapping table. If there is an overlap, at step 612, the LBAs that map to blocks of flash memory device 135 that are marked dirty are flushed to storage disk 110 and the LBAs that map to blocks of flash memory device 135 that are not marked dirty are marked invalid (e.g., valid bit is changed from 1 to 0 or the entry removed from the table). The storage disk mapping table is then updated accordingly at step 614. Then, the entire read data is retrieved from storage disk 110 at step 616 using the storage disk mapping table.

In alternative embodiments, instead of carrying out steps 612 and 614 when there is an overlap in the LBAs of the read command so that they map to both blocks of flash memory device 135 and blocks of storage disk 110, separate reads may be issued to flash memory device 135 and storage disk 110 so as to retrieve a part of the read data from flash memory device 135 and the remaining part of the read data from storage disk 110.

While the foregoing is directed to embodiments, other and further embodiments may be devised without departing from the basic scope thereof, and the scope thereof is determined by the claims that follow.

We claim:

1. A method of writing data in a data storage device having a magnetic storage medium divided into addressable blocks and a non-volatile solid-state device divided into addressable blocks, said method comprising:
receiving a command to write data;
determining that the non-volatile solid-state device has a valid block with a logical address referenced by the command;
writing the data to a block of the magnetic storage medium, which has the same logical address as the valid block of the non-volatile solid-state device; and
after said writing, invalidating the valid block of the non-volatile solid-state device.

2. The method of claim 1, wherein the command references a plurality of logical addresses, one of which is the logical address of the valid block.

3. The method of claim 2, wherein said determining, said writing, and said invalidating after said writing are carried out for all valid blocks of the non-volatile solid-state device that have a logical address referenced by the command.

4. The method of claim 1, further comprising:
adding the logical address to a list of logical addresses of blocks of the non-volatile solid-state device to be invalidated; and
processing the list to invalidate the blocks of the non-volatile solid-state device.

5. The method of claim 4, wherein the logical address is added to the list after said writing.

6. The method of claim 4, wherein said processing is performed asynchronously with respect to any commands to write data.

7. The method of claim 1, further comprising:
tracking validity of blocks of the non-volatile solid-state device with a validity/invalidity indicator, wherein a logical address of each of the blocks of the non-volatile solid-state device has a validity/invalidity indicator associated therewith.

8. The method of claim 7, wherein, when the list is processed to invalidate the blocks of the non-volatile solid-state device, the validity/invalidity indicator associated with the blocks indicate that the blocks are invalid.

9. A method of reading data from a data storage device having a magnetic storage medium divided into addressable blocks and a non-volatile solid-state device divided into addressable blocks, said method comprising:
receiving a command to read data from a block associated with a logical address;
determining whether or not the logical address is included in a list of logical addresses of blocks of the non-volatile solid-state device to be invalidated; and
based on said determining, reading the data from a block of the magnetic storage medium or a block of the non-volatile solid-state device.

10. The method of claim 9, wherein the data is read from the block of the magnetic storage medium if the logical address is included in the list or if the logical address is not associated with a valid block of the non-volatile solid-state device.

11. The method of claim 10, wherein the data is read from the block of the non-volatile solid-state device if the block is a valid block and the logical address is not included in the list.

12. The method of claim 11, further comprising:
tracking validity of blocks of the non-volatile solid-state device with a validity/invalidity indicator, wherein a logical address of each of the blocks of the non-volatile solid-state device has a validity/invalidity indicator associated therewith.

13. A data storage device, comprising:
a magnetic storage medium divided into addressable blocks;
a non-volatile solid-state device divided into addressable blocks; and
a controller configured to control writing of data to blocks of the magnetic storage medium and to blocks of the non-volatile solid-state device in response to a command to write data to a block associated with a logical address and to invalidate the block of the non-volatile solid-state device associated with the logical address after writing the data in a block of the magnetic storage medium associated with the logical address if the non-volatile solid-state device has a valid block associated with the logical address.

14. The device of claim 13, wherein the controller is configured to track validity of blocks of the non-volatile solid-state device with a validity/invalidity indicator.

15. The device of claim 14, wherein the controller is configured to add the logical address to a list of logical addresses of blocks of the non-volatile solid-state device to be invalidated, prior to invalidating the block of the non-volatile solid-state device associated with the logical address.

16. The device of claim 15, wherein the controller is configured to process the list to invalidate the blocks of the non-volatile solid-state device.

17. The device of claim 16, wherein the logical address is added after said writing, and said processing is performed asynchronously with respect to any commands to write data.

18. The device of claim 13, wherein the controller is configured to:
receive a command to read data from a block associated with a logical address;
determine whether or not the logical address is included in a list of logical addresses of blocks of the non-volatile solid-state device to be invalidated; and
read the data from a block of the magnetic storage medium or a block of the non-volatile solid-state device.

19. The device of claim 18, wherein the data is read from the block of the magnetic storage medium if the logical address is included in the list or the logical address is not associated with a valid block of the non-volatile solid-state device.

20. The device of claim 19, wherein the data is read from the block of the non-volatile solid-state device if the block is a valid block and the logical address is not included in the list or the logical address.
